(19) United States
(12) Patent Application Publication
(10) Pub. No.: US 2026/0109086 A1
(43) Pub. Date: Apr. 23, 2026

(54) METHOD OF FORMING A BONDED STRUCTURE

(71) Applicant: Lockheed Martin Corporation, Bethesda, MD (US)

(72) Inventors: Felix Nhanchau Nguyen, Parker, CO (US); Yin-Farn Chen, Shelton, CT (US); William P. Fallon, Wallingford, CT (US); Robert Warner Koon, Acworth, GA (US)

(21) Appl. No.: 18/921,746

(22) Filed: Oct. 21, 2024

(51) Int. Cl. B29C 35/02; B29C 65/00; B29C 65/48

(52) U.S. Cl. CPC B29C 35/0288; B29C 65/4835; B29C 66/721

(57) ABSTRACT

A method of forming a bonded structure is disclosed herein. In some embodiments, a method includes curing a first part on a first tool to a first degree of cure, the first degree of cure (DOC) being a partially cured state, removing the partially cured first part from the first tool, assembling the partially cured first part and a second part into a structure, and curing the structure to form a bonded structure, where the partially cured first part is cured to a second degree of cure (DOC) that is greater than the first DOC.

### FIELD OF THE DISCLOSURE

The present disclosure is related to a method of forming a bonded structure and a bonded structure formed by the same. The method produces a bonded structure at reduced time and/or cost.

### BACKGROUND OF THE DISCLOSURE

Adhesive bonding is a conventional process for forming composite bonded structures, such as those structures comprising thermoset resins with structural supporting members, such as fibers. The adhesive bonding can be performed by a number of curing processes, such as co-bonding or secondary bonding.

In a co-bonding process, a cured part is joined to an uncured part via an adhesive, where the uncured part and the adhesive are cured during the co-bonding process. The cured part has been pre-cured (i.e., prior to assembly with the uncured part) such that the cured part is in a ‘fully’ cured state (i.e., a final state of curing) prior to assembly. The degree of cure for a part to be considered ‘fully’ cured may vary based on aspects of a particular part, such as size, shape, material, desired mechanical properties, and the like. In some cases, a ‘fully’ cured part has an averaged degree of cure from locations of interest in the part of at least about 90%, which adds additional time and cost, prior to the start of the co-bonding process.

In a secondary bonding process, a fully cured part is joined to a second fully cured part via an adhesive, where the adhesive is cured during the secondary bonding process. Each fully cured part has been pre-cured such that the cured parts have an averaged degree of cure from locations of interest in the part of at least about 90%, which adds additional time and cost, prior to the start of the secondary bonding process.

Because of the need to fully cure a part over an extensively long cycle, depending on the part's geometry, and then separately fully cure another part and/or adhesive through another extensively long cure during the bonding process, both the co-bonded and secondary bonded structures can have a baseline time period for completion of days or weeks. Moreover, for timely production, an elevated temperature is needed to cure the part prior to assembly for bonding, which typically requires high temperature capable tool which adds additional costs. Further, because at least one or both parts are fully cured prior to bonding, chemical group functionality needed to form consistently reliable and/or stronger bonds at surfaces of the cured parts may not be available during the bonding process. As such, surface preparation to roughen the surface such as hand sanding, and/or add chemical functional group such as plasma onto the surface is needed for reliable bonding purposes, which adds additional time and cost.

There is a need in the art for improved methods of forming a bonded structure using rapid low-cost low-temperature tool, and/or with shorter production time leveraging innovative material solutions and simulation-based process optimization to achieve the bonded structure at higher rates and/or at lower costs, and/or with more consistently reliable and/or higher bonding strength.

### BRIEF SUMMARY OF DISCLOSURE

Methods of forming a bonded structure are disclosed herein.

In an exemplary embodiment of the present disclosure, a method of forming a bonded structure comprises curing a first part on a first tool to a first degree of cure, wherein the first degree of cure (DOC) being a partially cured state; removing the partially cured first part from the first tool; assembling the partially cured first part and a second part into a structure; and curing the structure to form a bonded structure, wherein the partially cured first part is cured to a second degree of cure (DOC), wherein the second DOC is greater than the first DOC.

In an exemplary embodiment of the present disclosure, a bonded structure, comprises a first part; a second part; and an adhesive layer coupling the first part to the second part, wherein cohesive failure area of a fractured bonded surface is higher than adhesive failure area and is at least 50% of the total fractured bonded surface area. wherein cohesive failure is that of the adhesive layer, and wherein adhesive failure is that between the adhesive layer and the first and/or second part.

### BRIEF SUMMARY OF DRAWINGS

To assist in understanding the present disclosure, reference is now made to the following description taken in conjunction with the accompanying drawings, in which:

FIG. 1 depicts a flow chart of a method for forming a bonded structure in accordance with some embodiments of the disclosure.

FIG. 2A depicts a schematic view of a part for a bonded structure in accordance with some embodiments of the disclosure.

FIG. 2B depicts an exploded schematic view of parts for a bonded structure in accordance with some embodiments of the disclosure.

FIG. 2C depicts a schematic view of a bonded structure in accordance in accordance with some embodiments of the disclosure.

FIG. 3 depicts a schematic view of material state profiles in accordance with some embodiments of the disclosure.

FIG. 4 depicts a schematic view of temperature profiles to obtain a material state in accordance with some embodiments of the disclosure.

FIG. 5 depicts a schematic view of two fractured surfaces of a bonded structure after failure in accordance with some embodiments of the disclosure.

FIG. 6 depicts a side schematic view of a part of a bonded structure in accordance with some embodiments of the disclosure.

FIG. 7 depicts a side schematic view of a part of a bonded structure in accordance with some embodiments of the disclosure.

### DESCRIPTION

Methods of forming a bonded structure are disclosed herein. The method produces a bonded structure at reduced time and/or cost. The method may utilize rapid low-cost low-temperature tools, materials, processes, and/or cure method to form bonded structures with consistently reliable and/or higher bonding strength.

It should be understood at the outset that, although example implementations of embodiments of the disclosure are illustrated below, the present disclosure may be implemented using any number of techniques, whether currently known or not. The present disclosure should in no way be limited to the example implementations, drawings, and techniques illustrated below. Additionally, the drawings are not necessarily drawn to scale.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both structure and several, unless expressly indicated otherwise or indicated otherwise by context. Therefore, herein, “A and B” means “A and B, structurally or severally,” unless expressly indicated otherwise or indicated otherwise by context.

The use of the terms “a” and “an” and “the” and similar referents in the context of describing the invention (especially in the context of the following statements) are to be construed to cover both the singular and the plural, unless otherwise indicated herein or clearly contradicted by context. As used in this document, “each” refers to each member of a set or each member of a subset of a set. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. Moreover, recitation of a range such as “of A to B”, or “from A to B”, or “between A to B”, or any recitation of range is intended to include the endpoints A and B. The use of any and all examples, or exemplary language (e.g., “such as”) provided herein, is intended merely to better explain the disclosure and does not pose a limitation on the scope of statements.

The use of terms ‘overlying’, ‘underlying’, ‘disposed on’ and similar referents in the context of the present disclosure are to be construed to cover both being separated and in direct contact with an adjacent structure. For example, a first layer ‘overlying’ or ‘disposed on’ a second layer means the first layer is above the second layer, where the first layer may be separated from the second layer by one or more intervening layers or the first layer may be in direct contact with the second layer. The terms ‘overlying’, ‘underlying’, ‘disposed’ are not intended to be construed to exclusively mean ‘in direct contact with’ an adjacent structure.

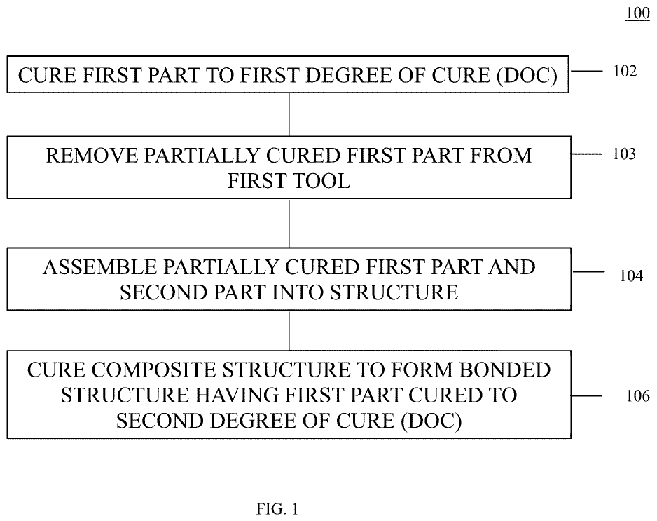

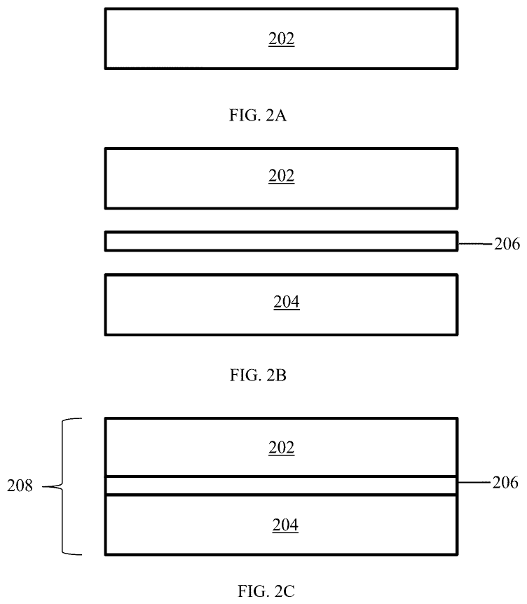

FIG. 1 depicts a flow chart of a method 100 for forming a bonded structure in accordance with some embodiments of the disclosure. The method 100 is described below concurrently with process steps depicted in FIGS. 2A to 2C.

At 102, a first part 202 (shown in FIG. 2A) may be cured on a first tool to a first degree of cure (DOC).

After curing to the first DOC, the first part 202 is in a partially cured state. The first DOC may vary based on size, shape, materials, and the like of a given part. A part having the first DOC is in a partially cured state, where the partially cured state is relative to a state that is considered final or ‘fully’ cured for that particular part. The first DOC may be between about 5% to about 90%. In some embodiments, the first DOC may be selected based on the identity of the part or type of application for which the part is being used. In some embodiments, the first DOC may be less than 50%, less than 30%, or less than 10% for a small part because of adequate handle-ability of the small part. In some embodiments, the first DOC may be less than 40% for a part used in a repair, for example, where the shape of the repair area is irregular and malleability, conformability, and/or drape-ability of the part to the shape of the repair area is necessary. In some embodiments, the first DOC may be about 50% to about 85%, at least about 60%, or about 60% to about 85%, or greater than about 65% to about 85%, at least about 70%, or about 70% to about 85%, or greater than about 70% to about 85% for a large part because of inadequate handle-ability of the large part, such shape deformation under the weight of its size. In some embodiments, achieving a desired first DOC for a bonded structure having desired performance requires an engineering effort to determine a balance between handle-ability and surface readiness for bonding. For example, in some applications a first DOC between 55% to 65% is sufficient for handle-ability and allows more chemical functional groups on the surface for bonding whereas in some application a first DOC between 65% to 85% is needed to meet handle-ability requirements (such as dimension tolerances after cured, drilling/machining prior to bonding operations, impact damages and deformation during moving, and/or causing quality issues to the resulting bonded structure) but at the expense of just having enough chemical functional groups on the surface for bonding. The material selection, the first tool selection, and a cure profile are also engineered to reach the first DOC achieving an optimal balance in cost and rate of manufacturing the first part 202 and thus contributing to the improved cost/rate of the application to a maximum extent.

In some embodiments, controlling curing of the first part through the first DOC rather than the current state of the art baseline with a cure cycle will provide a method for rapidly determining the right cure cycle from hundreds, thousands or even indefinite number of cure cycles comprising combinations of temperature, time and ramp rate, ease of transition from one cure equipment to the next, changing one first tool to the next, or other reasons.

Curing the first part 202 to the first DOC may begin by applying a first curing profile. During the first curing profile the first part may remain above a threshold temperature for a first elapsed time and reach a first critical temperature during the first elapsed time, where the first critical temperature may be greater than the threshold temperature. The cure profile is determined based on factors, such as shape, size and composition of the first part and/or first tool and/or cure equipment and is discussed further below. The first part 202 may have some variation in degree of cure at different locations on the first part 202, for example, at bent location compared to a flat location, at locations at different thicknesses, at locations that experience different air flow in the first tool, and the like. Thus, the first part 202 cured to a first DOC may mean that about 60% to about 95%, more than about 60%, more than about 70%, more than about 80%, more than 90% or more than 95% of locations on the part have reached the first DOC. For example, the majority of locations may be within about 10%, within about 5%, or within about 3% of the first DOC value.

The first critical temperature may range from about 150 ° F. to about 325 ° F. In some embodiments, the first critical temperature may be at most about 300 ° F. The first elapsed time may be at most about 480 min. In some embodiments, the first elapsed time may be at most about 3 min, at most about 10 min, at most about 20 min, at most about 30 min, at most about 60 min, about 30 min to about 60 min, about 60 min to about 180 min, and/or about 120 min to about 480 min. The threshold temperature may range from about 100 ° F. to about 150 ° F.

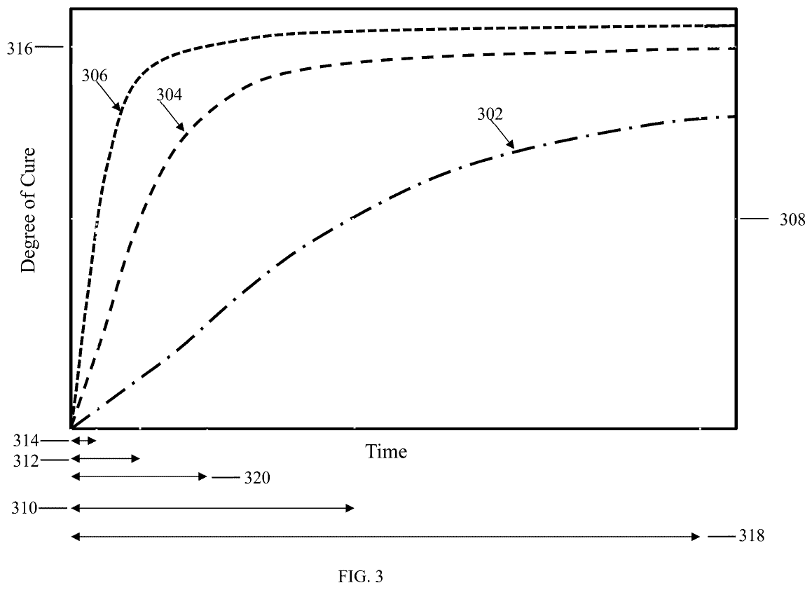

The first critical temperature and the first elapsed time are determined to produce the first DOC in the first part 202. After determination of the first elapsed time and the first critical temperature, the first curing profile may be applied to the first part 202 to heat the first part 202 above the threshold temperature for the first elapsed time during which the first part reaches the first critical temperature. For example, referring to FIG. 3, there can be numerous permutations of temperature and time that can be used to cure the first part 202 to the first DOC. FIG. 3 depicts a schematic view of material state profiles, where each can be obtained at a location of interest (of the first part 202) in accordance with some embodiments of the present disclosure. The material state, i.e., degree of cure, is shown as a function of time. FIG. 3 depicts degree of cure profiles 302, 304, and 306, where the critical temperature applied to the first part 202 increases, in order, from profile 302 to 306. For example, by applying the lowest critical temperature, the first part 202 may reach the first DOC (represented by line 308) in the longest elapsed time 310 as depicted in profile 302. By comparison, using profile 304, having a higher critical temperature than profile 302, the first part 202 reaches the first DOC after elapsed time 312 which is shorter than elapsed time 310. By using profile 306, having even a higher critical temperature than profile 304, the first part 202 reaches the first DOC after elapsed time 314 which is shorter than both elapsed time 312 and elapsed time 310.

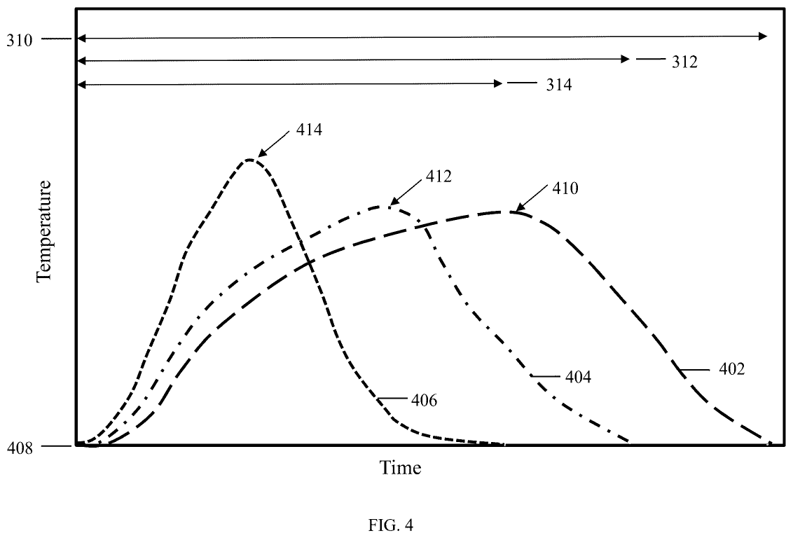

Exemplary curing profiles of the first part 202 during curing at 102 are depicted in FIG. 4. Curing profiles 402, 404, and 406 correspond to DOC profiles 302, 304, and 306, respectively, and result in the same first DOC by different combinations of elapsed time and critical temperature. For example, curing profile 402 has the elapsed time 310, where the elapsed time 310 is the time the first part 202 spends above the threshold temperature (represented by x-axis 408 in FIG. 4) During the elapsed time 310, the first part 202 reaches a critical temperature 410. In comparison, curing profile 404 has the elapsed time 312 and reaches a critical temperature 412, where the elapsed time 312 is shorter than elapsed time 310 and the critical temperature 412 is higher than the critical temperature 410. Curing profile 406 has elapsed time 314 which is shorter than either of elapsed times 310, 312 and reaches a critical temperature 414 that is higher than either of critical temperatures 410, 412. Each of curing profiles 402, 404, and 406 can result in the first part 202 having the same first DOC at the conclusion of the respective elapsed times 310, 312, and 314.

A process correlation may determine a relationship between DOC in the first part and temperature and time. The first critical temperature and the first elapsed time may be determined based on the process correlation to produce the first DOC in the first part.

The process correlation may be determined from at least one of a calibration curve having a functional relation between the first DOC and the first critical temperature and the first elapsed time, a lookup table having paired values of the first critical temperature and the first elapsed time that produce the first target DOC, a semi-empirical DOC model of the first part, a plurality of DOC simulations of the first part for a plurality of DOC distinct process conditions, wherein the DOC simulations include thermal chemical models, or experimental measurement.

A semi-empirical DOC model may be utilized to determine the degree of cure evolution as a function of temperature, time and geometry. The semi-empirical model may include an equation describing a physics-based relationship among cure rate, temperature and time. Depending on materials, the coefficients and terms might be different. The model may include density, specific heat capacity, thermal conductivity, and heat of reaction. Additional relevant parameters of the model may include but not limited to rate of conversion, activation energy, rate constant, glass transition temperature, pre-exponential factor (Arrhenius rate constant), gas constant, Di-Benedetto parameter (a parameter controlling the convexity of the evolution curve), heat transfer coefficient, and diffusion kinetics.

The DOC simulation may include thermal chemical models, which is numerical solutions of the equation. Examples of commercial software packages include RAVEN and COMPRO available from Convergent Manufacturing Technologies. The plurality of DOC distinct process conditions includes at least one of a plurality of different heated environment temperatures utilized during heating the first part providing different heat transfer coefficients between the heated environment and the first part, a plurality of different heating rates for the first part, a plurality of different materials and thicknesses for the first part, a plurality of different materials, thicknesses, thermal conductivity, heat capacity and density for tool.

Experimental measure may include, for example, curing a plurality of a first part 202, each to different times and/or temperatures of interest, removing one or more samples of each first part 202 at one or more locations of interest, and analyzing the one or more samples via differential scanning calorimetry (DSC) to obtain a DOC of the one or more samples. From an analysis of the plurality of first parts, an evolution of DOC as a function of time and temperature can be determined. Cure profiles may be developed based on the experimental measurements. Because of the trial-and-error nature of this experimental process, simulation-based process optimization may be more preferred to track and monitor evolution of DOC(s). In contrast, the current state of the art baseline is to obtain the local DOC(s) by DSC measurement at the end of the cure rather than during the cure to avoid cure disruptions resulting in a poor quality of the first part. Thus, evolution of DOC is not determined in the current state of the art.

During curing at 102 (and at 106 discussed below), the first part 202 can be monitored at one or more locations using temperature sensors. There may be variation in temperature at one or more of the locations being monitored. For example, variation could be due to, but not limited to, shape of the part, thickness, materials being cured, cure equipment, tool and/or combinations. For example, cure equipment may be equipment used to cure a part, such as autoclave, oven, press, and the like. For example, tool may be equipment used to shape or form the part then the part may be cured on the tool when placed in cure equipment, such as a mandrel to lay up plies for a part. For example, different locations on the first part could reach the threshold temperature or the first critical temperature at different times. The first elapsed time at each location may begin and end at different times at each location. Some locations might reach the first critical temperature (i.e., leading locations) and some might not (i.e., lagging locations). Thus, based on the monitored temperatures at each location of the first part, it must be decided, for example, when to end curing at 102. In some embodiments, a select location could be monitored for the temperature of the first part, and the curing at 102 could be ended based on the temperature monitored at the selected location. In some embodiments, an average of the temperatures from all locations can be determined, and the curing at 102 could be ended based on the average temperature at all the locations being monitored. In some embodiments, the lowest and the highest temperature measured at all the locations can be determined, and the curing at 102 could be ended based on when the resulting lowest and highest first DOCs reach a desired cured state range and/or a desired averaged value of the lowest and highest first DOCs.

In some embodiments, an average value of the first DOC (i.e., at all locations on the part) may be less than 90%. In some embodiments, an averaged first DOC value at all locations on the part or of the lowest and highest first DOCs may be about 55% to about 85%, at least about 60%, about 60% to about 85%, greater than about 65% to about 85%, at least about 70%, about 70% to about 85%, and/or greater than about 70% to about 85%.

The first DOC may be selected to provide sufficient handle-ability of the partially cured first part 202 during transportation, assembly, bonding, and cure operations to form a bonded structure. Testing or characterization to ensure sufficient handle-ability may include, but is not limited to, drilling/machining, environmental conditioning, impact, bend, fracture toughness, and tension/compression. In some embodiments, the first DOC may be further selected to minimize or eliminate process-induced defects such as deformations, dimension tolerance challenges and/or quality challenges as resulted from the first cure of the partially cured first part 202 and the second or final cure of the cured bonded structure. In some embodiments, the first DOC may be further selected to minimize or eliminate surface preparation steps for bonding such as hand-sanding and plasma while providing a consistent bond strength or a narrow bond strength distribution.

The use of a partially cured parts may result in stronger bonds compared to conventional bonding processes which bond parts. The partially cured parts can result in increased strength of the bonded areas due to interdiffusion between material of the part having available chemical functional groups and the adhesive during the bonding process. In contrast, conventionally bonded structures, formed from cured parts, may not have interdiffusion due to not having chemical functional groups. The bonded structures of the present disclosure may have a higher ratio of cohesive failure area to adhesive failure area compared to a conventional bonded structure, i.e., during testing to failure the bonded structure may experience cohesive failure, e.g., an individual part or an adhesive layer may fail/break, before adhesive failure, e.g., a bond between an adhesive layer and a part may fail/break.

The conventional method of either secondary bonding or co-bonding, which uses a fully cured part prior to assembling and curing the bonded structure, has limited cross linking or chemical bonding at an interface (e.g., between a fully cured part and an adhesive layer) because of limited amount of chemical functional groups available in the fully cured part. Bond quality in the conventional method typically relies on surface preparation on the fully cure part, such as surface roughening through hand-sanding, grit blast, laser ablation or similar, which activates mechanical interlocking during bonding to an adhesive to ensure an adequate interfacial bond strength.

In contrast, the inventive method may allow for additional cross-linking or chemical bonding at the interface because of abundant chemical functional groups available in a partially cured part. Surface preparation to facilitate and/or improve bond quality may be reduced or even not needed because of additional cross-linking or chemical bonding at the interface which may result in a stronger interfacial bond strength that may be independent of the effect of surface preparation and/or contamination.

The bonded joint strength can be empirically expressed as (xc)*(Fc)+(xa)(Fa). Here, xc and xa represent the percentage of cohesive and adhesive failure area on the fractured surfaces, respectively. Fc denotes the adhesive's intrinsic strength, while Fa signifies the interfacial strength between the adhesive and the part. The inventive method may enhance the value of Fa by introducing the interfacial cross linking or chemical bonding during the bonding process. Experimental data suggests that a higher Fa value generally corresponds to a lower value of xa and higher value of xc. Higher ratio of cohesive failure are to adhesive failure area indicates better bonding quality. A reasonably good bond typically has at least 50% cohesive failure area of total fractured surface.

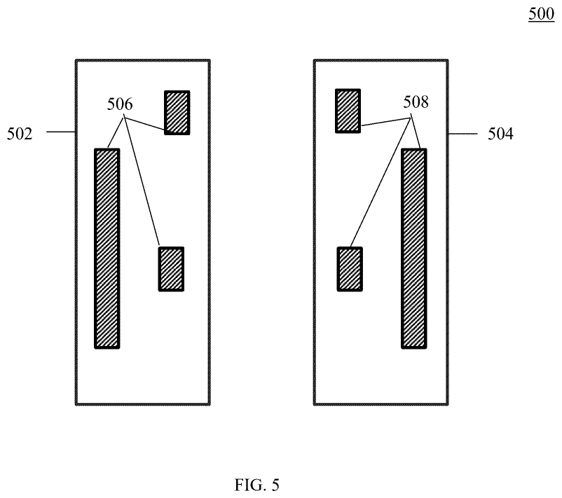

Testing to quantify bond strength or performance of the bonded structure is typically cost and time intensive due to building the bonded structure and engineering a right test method to obtain meaningful quantifiable number. As the results performing more tests at coupon level, some tests at element level and very limited build and test at structure levels are needed. To quantify the impact of partially cured part on bonded strength or performance of the bonded structure, one could use, examine or investigate available measured bonded strengths and distribution from one or more coupon tests such as wedge crack, single lap-shear, double lap-shear, flat-wise tension, double cantilever beam (DCB), end-notched flexure (ENF) or similar, preferably DCB; or from one or more element tests such as pull-off and shear tests; or from engineered structure tests. In the absence of measured bonded strengths and distribution, a good indicator of consistently reliable and/or higher bonding strength could be from the ratio between cohesive failure area to adhesive failure area from a fractured surface of the bonded article. The present invention might produce cohesive area of the total fracture surface of at least about 50%, at least about 60%, at least about 70%, between about 75% to about 90% or at least 90% and have a narrow distribution. For example, FIG. 5 depicts a schematic view of two separated fractured surfaces of a bonded joint 500 after failure in accordance with some embodiments of the present disclosure. The bonded joint 500 includes a first part 502 and a second part 504, and an adhesive layer therebetween. After failure, the surface of the first part 502 may retain retains a portion 506 of the adhesive layer and the second part 504 may retain a portion 508 of the adhesive layer. The retained portions 506 and 508 may represent the cohesive failure area of the total fracture surface, e.g., the failure occurred in the adhesive layer and not between the part 502, 504 and the adhesive layer.

The cost/rate improvement of the bonded structures in the present invention can be realized from one of more of the followings (1) manufacturing of partially cure state of any of parts in the structure prior to assembling the structure in shorter times, (2) leveraging rapid cure materials and low-temperature tool to manufacturing partially cured parts in lower temperature and/or shorter time, (3) leveraging low-temperature tools that are inexpensive and multiple uses when manufacturing partially cured parts at lower temperature than the rated tool temperature, (4) reducing or eliminating surface preparation, (5) improving bond reliability and/or strength, which leads to testing/inspection reduction at coupon level, element level and/or structure level, (6) improving cost avoidance. The cost/rate improvement is depending on applications and structure requirements might be at least about 15%, at least about 20%, at least about 30%, between 20-50%, at least 50% compared to the current state of the art in that prior to assembling the structure, manufacturing fully cured parts on high temperature expensive metal tools, performing surface preparation for the fully cured parts, and performing testing/inspection of the bonded structure.

At 103, the partially cured first part 202 is removed from the first tool. The methods disclosed herein may facilitate the use of low-cost low-temperature tool. For example, the first part 202 is cured using lower temperatures, such as about 350 ° F. or below, and shorter cure times, which may allow pro-longed use of the tool. Exemplary tool may be lost core tool from Fiber Dynamics, Smart Tool using shape memory tooling from Hawthorn Composites, thermoplastic or fiber-filled thermoplastic tool by big area additive manufacturing (BAAM) or large-scale additive manufacturing (LSAM), metal-filled polymer tool, sheet-metal formed tool from Machina Labs, and/or the like. Exemplary tool may be produced using processing methods for polymer materials and their composites (e.g., press-molding, 3D printing, injection molding, resin infusion, casting and machining, prepreg layup and autoclave/oven cure), and low-cost metallic materials (e.g., casting, machining, 3D printing, sheet metal forming (i.e. roboforming)), and/or the like. In some embodiments, the first tool comprises at least one polymer constituent having a dry glass transition temperature of at least about 125 ° F., at least about, 150 ° F., at least about 175 ° F., at least about 200 ° F., at least about 225 ° F., or at least about 250 ° F. A higher dry glass transition temperature of the polymer tool is more preferred to prolong use of the tool at a higher molding temperature. Examples of such polymer and reinforcement-filled composites include, but not limited to, thermoset resins with their applicable curing agents (e.g., epoxy resins, epoxy novolac resins, ester resins, vinyl ester resins, cyanate ester resins, maleimide resins, bismaleimide resins (BMI), bismaleimide-triazine resins, phenolic resins, novolac resins, resorcinolic resins, unsaturated polyester resins, diallylphthalate resins, urea resins, melamine resins, benzoxazine resins, polyimide resins, polyurethanes, their derivatives, or mixtures thereof), thermoplastics (e. g, polyvinyl formals, polyamides, polycarbonates, polyacetals, polyphenyleneoxides, polyphenylene sulfides, polyarylates, polyesters, polyamideimides, polyimides, polyetherimides, polyimides having phenyltrimethylindane structure, polysulfones, polyethersulfones, polyetherketones, polyetheretherketones, polyaryletherketone, polyaramids, polyethernitriles, polybenzimidazoles, their derivatives or their mixtures thereof), shape memory materials, and foams.

The first tool may have a life-cycle of at least about 10, for example, meaning that the tool can be used 10 times before replacement is needed. The number of life-cycles at a given first critical temperature and first elapsed time to produce the first part 202 can be determined by experiments and/or modeling. In some embodiments, the life-cycle may be at least about 50, about 50 to about 100, or at least about 100. For example, a carbon fiber reinforced epoxy or BMI 350 ° F.-rated tool could last about 10 life-cycles if the first part is cured at 350 ° F. for 120 min, about 20 life-cycles or higher at 350 ° F. for 60 min, 300 ° F. for 90 min, or 250 ° F. for 180 min; on the other hand a carbon fiber reinforced polycarbonate 250 ° F.-rated tool could last about 10 life-cycles if the first part is cured at 250 ° F. for 120 min, about 20 life-cycles or higher at 250 ° F. for 60 min, 225 ° F. for 90 min, or 200 ° F. for 180 min.

The configuration of the tool surface for the first tool may be dependent on the geometry of the part being cured in the tool. The configuration may be a flat laminate, such as a web within an aircraft rib, spar, bulkhead, keel or frame. The configuration may contain some degree of curvature for parts such as an aircraft wing skin, fuselage skin, door surface, access panel surface, and/or controlled surfaces. The configuration may contain complex curvatures for parts such as an aircraft stringer and stiffened ribs, beaded ribs, stiffened spars, stiffened bulkheads, stiffened keels, and/or frames.

The tool may be tailored for single sided or match-mold processing. Single sided tool concepts are used in conjunction with fabrication processes such as autoclave, oven cure, RapidClave®, vacuum assisted resin transfer molding (VARTM), resin film infusion and diaphragm forming. Match-mold tool concepts are used in conjunction with fabrication processes such as resin transfer molding (RTM), stamp forming, thermal forming, press forming, compression molding, and injection molding.

In some embodiments, wherein there is a desire to just to improve bond reliability and/or bond strength for a certain cost/rate improvement rather than the overall ultimately improved cost/rate of bonded structures, a low-cost low-temperature first tool might not be needed; however, the present inventive method to cure the first part on the tool to the first DOC to achieve the partially cured first part is still applicable, as long as the selected cure temperature (higher or lower than 350 ° F.) and time will provide the first DOC. An example is a current production where an existing first tool (such as invar, steel, aluminum, composite tool) and an material [such as 3900, 3960 from Toray, 8552 from Hexcel, MTM45-1, 5320-1, 5250-4 from Syensqo (former Solvay), or any available fiber-reinforced thermoset polymer (such as epoxy, bismaleimide (BMI), cyanate ester, benzoxazine, any aerospace/defense grade polymer) from any supplier and at least the first part in the bonded structure is needed to be partially cured to facilitate consistently reliable and/or higher bond strength and reduce or to eliminate surface preparation such as hand sanding and/or plasma or a similar combined method.

Returning to FIG. 1, and at 104, the partially cured first part 202 and a second part 204 are assembled into a structure as depicted in an exploded view in FIG. 2B. The first part 202 and second part 204 may be assembled to each other (not shown) or one or more additional components 206 may be assembled between the first and second parts 202, 204.

The one or more additional components can include an additional part, an adhesive layer, a core layer (including metallic or non-metallic honeycomb and other suitable patterns), foam, a metallic or polymer-based insert, a structural health monitoring system, a metallic part, a glass, a non-metallic part, and/or the like. A metallic part may be a part that is a majority metal-containing part or has metallic properties. For example, a part consisting of aluminum may be considered a metal part. An exemplary metallic part may include a part comprising, consisting, or consisting essentially of a metal or metal alloy. Exemplary non-metallic parts may be, for example, a carbon-carbon part, a ceramic part (where the ceramic may contain metal atoms), a carbide part, such as silicon carbide, a thermoplastic part, or the like. Exemplary thermoplastic parts, which are non-curable parts, may comprising a thermoplastic material and optionally, a structural member, such as a fiber or other structural member as disclosed herein.

In some embodiments, the one or more additional components 206 may be an adhesive layer. In some embodiments, the one or more additional components may include a first adhesive layer, a third part, and second adhesive layer, where the first adhesive layer is arranged between the first part and the third part, and the second adhesive layer is arranged between the second part and the third part, wherein the first and the second adhesive might be the same and the third part could be a metallic part or non-metallic part. In some embodiments, such as sandwich constructions, the one or more additional components may include a first adhesive layer, a third part (i.e., a core layer), and second adhesive layer which is the same or different from the first adhesive layer, where the first adhesive layer is arranged between the first part and the third part, and the second adhesive layer is arranged between the second part and the third part. In some embodiments, such as 2D stiffen panels, the one or more additional components may include a first adhesive layer, a second adhesive layer which is the same of different from the first adhesive layer, and a third part, where the first adhesive layer is arranged between the first part and the third part, and the second adhesive layer is arranged between the second part and the third part, the first and second parts being identical parts. In some embodiments, such as 3D structures with engineered joints, such as Pi-joints and/or the like, wherein each comprises a Pi-preform comprising a base component and a pair of axially elongated legs coupled to the base component to define a channel between the axially elongated legs, the one or more additional components includes an additional part, i.e., the Pi-preform, a first adhesive layer, and second adhesive layer which is the same or different from the first adhesive layer. The first adhesive layer may be arranged between the first part and the base component of the Pi-preform, and the second adhesive layer is arranged between the second part and the pair of axially elongated legs of the Pi-preform to form the Pi-joint.

In some embodiments, the assembled parts may further include mechanical fasteners to reinforce the assembled parts to augment mechanical performance, such as crack arrest fasteners. The metallic mechanical fasteners may extend partially or completely through the thicknesses of the adjoining parts at periodic locations along the bonded areas. The mechanical fasteners would typically be installed after the final cure is completed. Further, mechanical linkages (i.e. clips), being composed of metallic or polymer, may be used to locate and support the assembled parts during the placement of the parts into or onto the second tool.

The second part 204 (and/or any additional parts) may be a curable part (e.g., a thermoset resin) or an uncurable part (e.g., a metallic part, a thermoplastic part, a carbide part, a carbon-carbon part, a ceramic part). In embodiments, where the second part 204 is curable, the second part 204 may be assembled with the partially cured first part 202 in a partially cured, uncured state or even fully cured. For example, if partially cured, the second part 204 can be cured in the same manner as disclosed herein at 104 for the first part 202. A partially second part 204 may be cured to a third DOC. In some embodiments, the third DOC may be the same as the first DOC. In some embodiments, the third DOC is different from the first DOC. For example, DOC of the second part 204 may be determined based on shape, size, and/or composition of the second part 204, location of the second part 204 within the assembled structure, or the configuration of the too. The DOC of the second part and/or additional parts, following the first cure, would typically target a value that would allow it to be fully cured upon completion of a second cure or a final cure.

Surface preparation might be required for the first part, the second part and/or additional parts prior to bonding. Abrading, media/grit blasting, chemical etching, laser etching/ablation, and other manual forms such as hand sanding are used to prepare or clean a surface to change its roughness. Furthermore, chemical functional groups might be introduced to the roughened surface by a surface treatment method such as plasma. Both vacuum plasma and atmospheric plasma including arc discharge, corona discharge, dielectric barrier discharge, its variation piezoelectric direct discharge and other suitable methods. For composite parts a fabric ply, a peel ply, a surfacing ply, a sacrificial ply, or a combination or the similar or the alike could be applied to roughen bonding surface of the part prior to other roughening methods or use without other roughening methods and/or surface treatment methods. In some embodiments, surface preparation and/or surface treatment methods might not be required as long as a consistent bond strength or a narrow bond strength distribution is achieved.

At 106, the structure is cured to form a bonded structure 208 as depicted in FIG. 2C. During curing, the partially cured first part 202 may be cured to a second degree of cure (DOC). The second DOC is greater than the first DOC. When the second part 204 (or any additional components 206) is a curable part, the second part 204 (or any additional components 206) may also be cured to the second DOC. Alternatively, the second part 204 (or any additional components 206) may be cured to a fourth DOC that is different from the second DOC. The fourth DOC may be lower or greater than the second DOC. The cure state of the second part 204 (or any additional curable part) may depend on the identity of the curable material of the part, the size of the part, the shape or use of the part within the structure, or the like. The second DOC in the present disclosure may be a final state of cure as long as performance of the bonded structure meets requirements. Alternatively, further curing after the second DOC is possible as discussed below. The second DOC may range from greater than about 85% to greater than about 90%. In some embodiments, the second DOC may range from about 85% to about 95%, or at least about 90%, or about 90% to about 95%. A second DOC lower than 85% or greater than 95% is possible as long as performance of the bonded structure meets requirements. Such an exemplary embodiment of the former may be a case where the assembly is cured to a desired DOC lower than fully cured, demolded and then gone through a free-standing post-cure in an oven to achieve fully cured.

Curing the partially cured first part 202, the second part 204, and/or any additional components 206 to the second DOC may begin by applying a second curing profile to the assembled composite structure. During the second curing profile the first part 202, the second part 204, and/or any additional components 206 may remain above a threshold temperature for a second elapsed time and reach a second critical temperature during the second elapsed time, where the second critical temperature may be greater than the first critical temperature, for example, so as to shorten cure time. The second cure profile is determined based on factors, such as shape, size and composition and partially cured state of the first part, second part, and/or any additional components and/or a second tool. The first part 202, second part 204, and/or any additional components 206 may have some variation in degree of cure at different locations based on, for example, at a bent surface compared to a flat surface, at surfaces of different thicknesses, at locations that experience different air flow in the first tool, and the like. Thus, curing to a second DOC may mean that about 60% to about 95%, more than about 60%, more than about 70%, more than about 80%, more than 90% or more than 95% of locations on the parts have reached the second DOC. For example, the majority of locations may range from about 85% to about 95%, or at least about 90%, or about 90% to about 95%. A second DOC greater than 95% is possible as long as performance of the bonded structure meets requirements.

Since each of the parts in the assembly might have different size, shape, composition from one another and starts at the same, similar or different first DOC from one another, the second critical temperature can result from a blend of critical temperatures, each determined by process correlation of the individual parts in the assembly. Similarly, the second elapsed time can result from a blend of elapsed times, each determined by process correlation of the individual parts in the assembly, wherein the second critical temperature and the second elapsed time can produce a second DOC for each individual part in a range of 85% to 95% to provide quality and bonded strength for the bonded structure. After selection of the second elapsed time and the second critical temperature, the partially cured first part 202, the second part 204, and any additional components 206 may be heated above the threshold temperature for the second elapsed time during which the first part 202, second part 204, and any additional components 206 reach the second critical temperature. Alternatively, a blend of critical temperature and elapsed time may be selected to produce, for example, a second DOC in the first part 202 and a fourth DOC in the second part 204, where the second and fourth DOC are different.

The second elapsed time may range from about 60 min to about 600 min or more. A longer time than 600 min might be needed if a lower second critical temperature is selected. The second critical temperature may range from about 300 ° F. to about 375 ° F. for a thermoset composition comprising epoxy resins, or about 350 ° F. to about 450 ° F. for cyanate ester resins, or about 375 ° F. to about 475 ° F. for bismaleimide resins, or about 450 ° F. to about 850 ° F. for polyimide resins, or another temperature range for a desired resin.

The second critical temperature and the second elapsed time may be determined by process correlation to produce the second DOC in the partially cured first part 202, second part 204, and/or any additional components 206. After determination of the second elapsed time and the second critical temperature, the second curing profile may be applied to heat the first part 202 above the threshold temperature for the second elapsed time during which the first part 204, second part 206, and/or any additional parts 206 reaches the second critical temperature. For example, referring again to FIG. 3, there can be numerous permutations of temperature and elapsed time that can be used to cure the first part 202 (and/or any curable parts in the assembly) to the second DOC. For example, by determination of the lowest critical temperature of the profile 302, the first part 202 may reach the second DOC (represented by line 316) in the longest elapsed time (not shown in FIG. 3). In comparison, using profile 304, having a higher critical temperature than profile 302, the first part 202 reaches the second DOC after elapsed time 318. By using profile 306, having even a higher critical temperature than profile 304, the first part 202 reaches the second DOC after elapsed time 320 which is shorter than elapsed time 318.

The second critical temperature and the second elapsed time are determined to produce the second DOC in the partially cured first part 202, the second part 204 (e.g., a curable second part 204), and/or any additional component 206 (e.g., curable additional components 206). A process correlation may provide a relationship between DOC in the first part, second part, and any additional components, and temperature and elapsed time. The second critical temperature and the second elapsed time may be determined based on the process correlation to produce the second DOC in the partially cured first part, the second part and/or any additional components. The method to establish process correlation to produce the first DOC discussed herein may be utilized to produce process correlation for the second DOC in the same manner. As discussed herein, process correlation may determine a critical temperature and elapsed time for each part in the assembly, for example, depending on the shape, size, first DOC, and the like of the individual parts in the bonded structure. The second critical temperature and the second elapse time may be determined by blending the critical temperatures and elapsed time determined by process correlation for each individual part (e.g., individual parts that are made of curable materials).

The assembled first and second part 202, 204 and/or any additional component 206 can be cured to the second DOC in a second tool. In some embodiments, the second tool may be comprised of the same materials as the first tool depending upon the temperature and elapsed time used for the second cure. In some embodiments, the second tool is a different tool that the first tool, for example, such as sized to accommodate the assembled first and second parts, formed of materials suitable for high temperature curing, and the like.

After the curing at 106 to the second DOC, the first part 204 has a cured wet glass transition temperature (Tg) of at least 200 ° F. for aerospace applications. For other applications outside of aerospace such as automobile and industrial segments, a lower cured wet Tg than 200 ° F. could be suitable. In some embodiments, the cured wet glass transition temperature (Tg) may be at least about 250 ° F. In some embodiments, after the curing at 106 to the second DOC, the first part might perform similar or equivalent to or higher than the first part that is cured to the fully cured state in a single cure cycle to reach the fully cured state. In some embodiments, the bonded joints with or without surface preparation prior to bonding might have bonding strength similar or higher while the strength distribution might be equivalent or narrower versus those from the baselines. Bonded joints might be measured at coupon levels using test methods such as double cantilever beam (DCB), end-notched flexure (ENF), flat-wide tension (FWT), double overlap shear (DOLS), single lap share (SLS), double lap shear (DLS), wedge crack, or the similar or the alike.

The bonded structure 208 can be any composite structure formed by co-bonding or secondary bonding, wherein at least one of the parts in the bonded structure is a curable composite material described herein. The bonded structure may be a composite bonded structure comprising curable parts in a bonded joint, a hybrid bonded structure (e.g. including uncurable parts and curable parts), a sandwich bonded structure comprising a core material, or include combinations thereof. The bonded structure may include independently, a pi-joint, a sandwich joint, an adhesive joint, and combinations thereof. In some embodiments, the bonded structure, for example, may have at least a pi-joint where the partially cured parts are attached via adhesives to different portions of a pi-preform (e.g., a third part), and the structure is cured using the method disclosed herein. Exemplary structures comprising at least a pi-joint include, but not limited to, aircraft wings, fuselages, bulkheads, door surrounds, frames, equipment housing, and rotorcraft blades. In some embodiments the bonded structure might have a sandwich joint, where one or more partially cured facesheets (e.g., first and second parts) are attached to a core material (e.g., a third part) via adhesives, and the structure is cured using the method disclosed herein. Exemplary structures comprising at least a sandwich joint include, but not limited to edges, airframes, rotorcraft blades, bus structures, and cylinders. In some embodiments, the bonded structure might have some parts bonded together by pi-joints, some parts bonded together by sandwich joints, and/or some solid part bonded to some solid part by an adhesive (e.g., adhesive joint). Exemplary of the bonded structure include, but not limited to, aircraft wings, fuselages, bulkheads, door surrounds, frames, edges, empennage, rotorcraft blades, tail cones, bus structures, cylinders, missile wings, equipment housing.

In some embodiments, the measured temperatures at various locations on the first part 202, the second part 206 and/or any additional components 206, on the first tool and the second tool, air temperature, and other locations in the cure equipment via thermocouples are necessary during cure development, prior to production, or prior to stable production. The measurements are used to establish relationships among these locations at a given time and calibrate or verify/validate DOC models, that is, once established if air temperature is known, then part temperature, tool temperature, and DOC (and other material states such as viscosity, glass transition temperature) can be predicted with confidence. The degree of confidence depends on the number of available datasets and if models are developed correctly to capture physics and intended outcomes. As such in production air temperature may be the only temperature that is monitored.

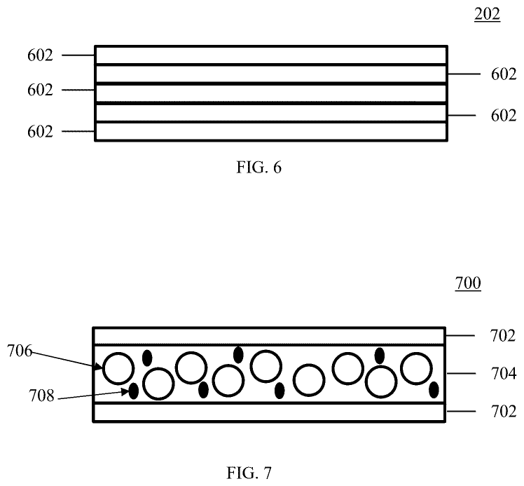

FIG. 5 depicts the first part 202 in accordance with some embodiments of the present disclosure. Though described herein with respect to the first part 202, the embodiments of FIG. 6 can be applied to any part in the bonded structure. The first part 202 may comprise a plurality of plies 502. Each ply 602 may range in cured ply thickness (CPT) from about 0.001 inches to about 0.02 inches. Each ply 602 may range in surface area from about 10 sq. in. to about 500 sq. ft. The part 202 can be formed of any suitable number of plies 602 to achieve a desired thickness, and/or structural characteristic. In some embodiments, a number of plies in a part may range from about 2 plies to 500 plies, or more than 500 plies to achieve up to 5 inches thick of the part.

The plies 602 may be a composite material that is curable. The composite material includes a resin composition. The composite material can further include a structural member, such as fibers and/or particles. The resin composition can be coated on and/or impregnated in the structural member. The resin composition can be cured by the methods of the present disclosure to form a composite part. In some embodiments, the first part 202 and the second part 204 may comprise the same or different resin composition. In some embodiments, (as discussed herein) the second part 204 maybe a metallic part or a thermoplastic part comprising a thermoplastic material with or without a structural member described herein.

The resin composition includes a thermoset resin. Thermoset resins may be any resin which can be cured with a curing agent or a cross-linker compound by means of an externally supplied source of energy, such as heat, light, electron beam, or other suitable methods to form a three-dimensional crosslinked network having the required glass transition temperature. Light energy may include electromagnetic radiation in the microwave and/or ultraviolet wavelength range. Suitable thermoset resins include, but are not limited to, epoxy resins, epoxy novolac resins, ester resins, vinyl ester resins, cyanate ester resins, maleimide resins, bismaleimide resins, bismaleimide-triazine resins, phenolic resins, novolac resins, resorcinolic resins, unsaturated polyester resins, diallylphthalate resins, urea resins, melamine resins, benzoxazine resins, polyimide resins, polyurethanes, their derivatives, or mixtures thereof. In some embodiments, the thermoset resin is a commercial polymer or an oligomer having a lower molecular weight than a commercial polymer.

In some embodiments, the resin composition further includes a hardener. The hardener may be used in a stoichiometric or non-stoichiometric ration relative to a resin. In some embodiments, the hardener may be included in an amount to completely crosslink with a corresponding thermoset resin, i.e., a stoichiometric ratio between the thermoset resin equivalent weight and the hardener equivalent weight. In some embodiments, the hardener may be included in an amount different from a stoichiometric ratio or up to about 75 parts by weight per 100 parts by weight of total thermoset resin (75 phr).

Suitable hardeners for epoxy resins include, but are not limited to, polyamides, dicyandiamide [DICY], amidoamines (e.g., aromatic amidoamines such as aminobenzamides, aminobenzanilides, and aminobenzenesulfonamides), aromatic diamines (e.g., diaminodiphenylmethane, diaminodiphenylsulfone [DDS] such as Aradur® 9664-1 and Aradur® 9719-1 from Huntsman Advanced Materials), aminobenzoates (e.g., trimethylene glycol di-p-aminobenzoate and neopentyl glycol di-p-amino-benzoate), aliphatic amines (e.g., triethylenetetramine, isophoronediamine), cycloaliphatic amines (e.g., isophorone diamine), imidazole derivatives, guanidines such as tetramethylguanidine, anhydrides (e.g., methylhexahydrophthalic anhydride), hydrazides (e.g., adipic acid dihydrazides [ADH], isophthalic dihydrazides [IDH], sebacic acid dihydrazides [SDH], valine dihydrazides [VDH], carbodihydrazides [CDH], icosanedioic acid dihydrazides, phthalic dihydrazide, terephthalic dihydrazide, 1,2,3-benzenetricarboxic trihydrazide, benzoic acid hydrazide, aliphatic monohydrazides, aliphatic trihydrazides, aliphatic tetrahydrazides, and aromatic monohydrazides, aromatic dihydrazides, aromatic trihydrazides, aromatic tetrahydrazides, p-toluenesulfonylhydrazide, benzenesulifinic hydrazide, benzenesulfonyl hydrazide, sulfuryl hydrazide, and phosphoric acid trihydrazide, 2-aminobenzoic hydrazide or 4-aminobenzoic hydrazide), hydrazines (e.g., phenylhydrazine, naphthalene hydrazine, 1-hexylhydrazine, p-phenylenebis(hydrazine), 1,6-hexamethylene dihydrazine, and 1,2-diphenyl hydrazine), phenol-novolac resins and cresol-novolac resins, carboxylic acid amides, polyphenol compounds, polysulfides and mercaptans, and Lewis acids and bases (e.g., boron trifluoride ethylamine, tris-(diethylaminomethyl) phenol), their derivatives, or combinations thereof.

Depending on type of hardener and its amount, curing of the thermoset resin composition can be advanced over time at ambient conditions. As cure advancement happens the material loses tack and become stiffer, which makes it less ideal to lay up the material on the first tool. Thus the time to use the material at ambient conditions (aka., out time) is reduced. Suitable out time for such resin compositions is at least 7 days, at least 14 days, between 14 to 42 days, or higher than 42 days.

In some embodiments, the resin composition may include a polymer additive. In some embodiments, the resin composition comprises from 0.1% to 40% (w/w) of a polymer additive, based on a total weight of the resin. In some embodiments, the resin includes at least 0.1% (w/w) of the polymer additive, or at least 1%, at least 2%, at least 3%, at least 4%, or at least 5% to less than 10%, less than 11%, less than 12%, less than 13%, less than 14%, or less than 40% (w/w) of the polymer additive, based on the total weight of the resin.

Exemplary polymer additives include accelerators, thermoplastic materials, fillers, or combinations thereof. In some embodiments, the accelerator can be any material that accelerates curing of the thermoset resin composition at a given temperature to achieve shorter time, lowers the cure temperature for the same time, or lower both cure temperature and shorten time. For example, in some embodiments, a DOC of greater than 50% of the first part can be achieved at temperatures ranging from about 200 ° F. to about 300 ° F. in about 240 min to about 5 min, about 120 min to 10 min, about 60 min to about 5 min, about 10 min to about 3 min, or between 5 min to 120 min at a given temperature between 200 ° F. to 300 ° F. The lower cure temperature and shorter time will lead to more material and process selections to fabricate the first tool and more life cycles of the first tool from fabricating the first part, which further reduce fabrication costs. Having an accelerator might lead to a reduction in out time. Suitable out time for such accelerated cure resin compositions is at least 7 days, at least 14 days, or between 14 to 42 days.

Suitable accelerators for epoxy resins include, but are not limited to, urea compounds, sulfonate compounds, boron trifluoride piperidine, p-t-butylcatechol, sulfonate compounds, tertiary amines or salts thereof, imidazoles or salts thereof, phosphorus curing accelerators, metal carboxylates, Lewis or Bronsted acids or salts thereof, or combinations thereof.

Suitable fillers include, but are not limited to, interpenetration network polymers, elastomers, branched polymers, hyperbranched polymers, dendrimers, rubbery polymers, rubbery copolymers, block copolymers, core-shell particles, oxides or inorganic materials such as silica, clay, polyhedral oligomeric silsesquioxanes (POSS), carbonaceous materials (e.g., carbon black, carbon nanotubes, carbon nanofibers, fullerenes), ceramics and silicon carbides, with or without surface modification or functionalization, or combinations thereof.

Suitable thermoplastic materials may include, but are not limited to, polyvinyl formals, polyamides, polycarbonates, polyacetals, polyphenyleneoxides, polyphenylene sulfides, polyarylates, polyesters, polyamideimides, polyimides, polyetherimides, polyimides having phenyltrimethylindane structure, polysulfones, polyethersulfones, polyetherketones, polyetheretherketones, polyaryletherketone, polyaramids, polyethernitriles, polybenzimidazoles, their derivatives or their mixtures thereof. In some embodiments, the thermoplastic resin is a commercial polymer or an oligomer having a lower molecular weight than a commercial polymer.

The fibers can be in any suitable shape and/or form. Non-limiting and exemplary fibers can include organic fibers and/or inorganic fibers. Organic fibers can include carbon fibers, polymer fibers, and the like. Inorganic fibers can include silicon fibers, metal fibers, and the like. The fibers can be arranged in any suitable configuration, such as randomly oriented, woven, bundled, matted, or the like. Exemplary fibers may include carbon fibers, glass fibers, aramid fibers, graphite fibers, boron fibers, or combinations thereof. In some embodiments, a ply comprises from 30 vol % to 85 vol % of aligned continuous fibers, based on the total weight of the ply. In some embodiments, the ply comprises at least 30 vol % of aligned continuous fibers 46, or at least 35 vol %, at least 40 vol %, at least 45 vol %, at least 50 vol %, at least 55 vol % to less than 60 vol %, less than 65 vol %, less than 70 vol %, less than 75 vol %, less than 80 vol %, or less than 85 vol % of the aligned continuous fibers.

In some embodiments, a ply may have a structure as depicted in FIG. 7. The ply 700 includes a plurality of regions. As shown in FIG. 7, the ply 700 includes two first regions 702 having second region 704 disposed therebetween. The first and second regions 702, 704 comprising a thermoset resin composition. The second region 704 includes structural members 706 and an accelerator 708. The first regions 702 does not have the accelerator or might have some gradient concentration of the accelerator from the second region due to manufacturing and thus acting as an insulator to minimize or prevent cure advancement of the second region at ambient conditions. The resulting ply 700 has an out time of at least 7 days, at least 14 days, or in between 14 to 42 days. During curing, the exemplary ply 700 can facilitate accelerated curing at lower temperatures. For example, in some embodiments, a DOC of greater than 60% can be achieved at temperatures ranging from about 200 ° F. to about 300 ° F. in a short period of time. In some embodiments, a DOC of greater than 90% can be achieved at temperatures of about 325 ° F. to 375 ° F. in a short period of time. The exemplary ply 700 can facilitate a lower thermal management and/or faster production of bonded structures.

The methods disclosed herein may be further applied to aftermarket applications. For example, aftermarket applications may include bonded repair, bolted repair, or the like. For example, in bolted repair, the methods disclosed herein may be utilized to form a bonded structure which then may be fastened in place via bolts or another mechanical fastening device. For example, in bonded repair, a portion of the damaged area may be removed. The portion of damaged area may be a first part and cured adhesive, for example. A partially cured replacement first part and adhesive may be applied and bonded to the existing structure. Composite structural prepreg repairs or reinforcements for part life enhancement requiring laminates comprising a number of plies greater than .030 inch thick are difficult without having to disassemble an aircraft and process parts in an autoclave. In-situ prepreg repair on an aircraft, due to the complex geometries and assemblies, presents challenges for heat distribution and pressure application where the process is limited typically to vacuum pressure and cure with a local heater blanket. This results in inferior laminates subject to voids and porosity often greater than 2% to 4%. Studies have shown a reduction in flexural strength by 1.5% for every 1% of porosity and interlaminar shear strength can be reduced by 20% with a 2% porosity condition. The proposed invention has been demonstrated to produce a partially cured fully consolidated laminate during a separate high pressure autoclave cure to create a void free patch that is still conformable to the substrate (metal or composite) part still on the aircraft. The partially cured patch, when subject to a secondary vacuum bag and heater blanket cure in-situ on the aircraft, has resulted in void free laminate bonds with no property knockdowns.

In an exemplary embodiment of the present disclosure, a method of forming a bonded structure comprises curing a first part on a first tool to a first degree of cure, wherein the first degree of cure (DOC) being a partially cured state; removing the partially cured first part from the first tool; assembling the partially cured first part and a second part into a structure; and curing the structure to form a bonded structure, wherein the partially cured first part is cured to a second degree of cure (DOC), wherein the second DOC is greater than the first DOC.

The method of the immediately preceding paragraphs, wherein the second part comprises a curable material, and further comprising curing the second part to a third degree of cure (DOC) prior to assembling the structure; and curing the second part after assembling the structure to a fourth degree of cure (DOC), wherein the fourth DOC is greater than the third DOC.

The method of any of the two preceding paragraphs, wherein the third DOC is the same as or different from the first DOC, and wherein the fourth DOC is different from the second DOC.

The method of any of the three preceding paragraphs, wherein the second part comprises a curable material and is uncured, prior to assembling the structure, and further comprising curing the second part after assembling the structure to the second DOC.

The method of any of the four preceding paragraphs, wherein assembling the first and second parts into the structure further comprises assembling the first and second parts with an adhesive layer therebetween, wherein the adhesive layer is partially cured or uncured.

The method of any of the five preceding paragraphs, wherein curing the first part to the first DOC further comprises applying a first curing profile, wherein, during the first curing profile, the first part remains above a threshold temperature for a first elapsed time and the first part reaches a first critical temperature during the elapsed time, and wherein the first critical temperature is greater than the threshold temperature.

The method of any of the six preceding paragraphs, wherein the first critical temperature and the first elapsed time are determined to produce the first DOC in the first part.

The method of any of the seven preceding paragraphs, wherein a process correlation determines a relationship between DOC in the first part and temperature and time, wherein the first critical temperature and the first elapsed time are further determined based on the process correlation to produce the first DOC in the first part.

The method of any of the eight preceding paragraphs, wherein the process correlation is determined from at least one of: (i) a calibration curve having a functional relation between DOC and temperature and time; (ii) a lookup table having paired values of the first critical temperature and the first elapsed time that produce the first DOC; (iii) a semi-empirical DOC model of the first part; (iv) an experimental measurement; or (v) a plurality of DOC simulations of the first part for a plurality of DOC distinct process conditions, wherein the DOC simulations include thermal chemical models, wherein the plurality of DOC distinct process conditions includes at least one of: (i) a plurality of different heated environment temperatures utilized during heating the first part providing different heat transfer coefficients between the heated environment and the first part; (ii) a plurality of different heating rates for the first part; (iii) a plurality of different materials and thicknesses for the first part; or (iv) a plurality of different materials, thicknesses, thermal conductivity, heat capacity and density for the first tool.

The method of any of the nine preceding paragraphs, wherein the first critical temperature ranges from about 150 ° F. to about 325 ° F.

The method of any of the ten preceding paragraphs, wherein the first DOC is at least 55% and less than 90%, and wherein the second DOC is at least 90%.

The method of any of the eleven preceding paragraphs, wherein, after the curing to the second DOC, the first part has a cured wet glass transition temperature (Tg) of at least 180 ° F.

The method of any of the twelve preceding paragraphs, wherein the first tool comprises at least a polymeric component having a Tg of at least 175 ° F. and the first tool has a life-cycle of at least 10.

The method of any of the thirteen preceding paragraphs, wherein the first part comprises a plurality of plies.

The method of any of the fourteen preceding paragraphs, wherein each ply in the plurality of plies includes a composite material, and wherein the composite material includes a resin composition and one or more fibers.

The method of any of the fifteen preceding paragraphs, wherein the resin composition has an out time of at least 7 days.

The method of any of the sixteen preceding paragraphs, wherein the resin composition reaches the first DOC over a time period of at most 180 min at the first critical temperature.

The method of any of the seventeen preceding paragraphs, wherein at least one ply has first regions and a second region therebetween, wherein the second region is cured faster than the first regions.

The method of any of the eighteen preceding paragraphs, wherein the second region includes the one or more fibers and a cure accelerating agent, and wherein the cure accelerating agent is present in a higher concentration in the second region than in the first regions.

The method of any of the nineteen preceding paragraphs, wherein the composite bonded structure comprises at least one of a pi-joint, an adhesive joint, or a sandwich joint.

In an exemplary embodiment of the present disclosure, a bonded structure, comprises a first part; a second part; and an adhesive layer coupling the first part to the second part, wherein cohesive failure area of a fractured bonded surface is higher than adhesive failure area and is at least 50% of the total fractured bonded surface area. wherein cohesive failure is that of the adhesive layer, and wherein adhesive failure is that between the adhesive layer and the first and/or second part.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended statements to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

1. A method of forming a bonded structure, comprising:
curing a first part on a first tool to a first degree of cure, wherein the first degree of cure (DOC) being a partially cured state;
removing the partially cured first part from the first tool;
assembling the partially cured first part and a second part into a structure; and
curing the structure to form a bonded structure, wherein the partially cured first part is cured to a second degree of cure (DOC),
wherein the second DOC is greater than the first DOC.

2. The method of claim 1, wherein the second part comprises a curable material, and further comprising:
curing the second part to a third degree of cure (DOC) prior to assembling the structure; and
curing the second part after assembling the structure to a fourth degree of cure (DOC), wherein the fourth DOC is greater than the third DOC.

3. The method of claim 2, wherein the third DOC is the same as or different from the first DOC, and wherein the fourth DOC is different from the second DOC.

4. The method of claim 1, wherein the second part comprises a curable material and is uncured, prior to assembling the structure, and further comprising curing the second part after assembling the structure to the second DOC.

5. The method of claim 1, wherein assembling the first and second parts into the structure further comprises:
assembling the first and second parts with an adhesive layer therebetween, wherein the adhesive layer is partially cured or uncured.

6. The method of claim 1, wherein curing the first part to the first DOC further comprises:
applying a first curing profile, wherein, during the first curing profile, the first part remains above a threshold temperature for a first elapsed time and the first part reaches a first critical temperature during the elapsed time, and wherein the first critical temperature is greater than the threshold temperature.

7. The method of claim 6,
wherein the first critical temperature and the first elapsed time are determined to produce the first DOC in the first part.

8. The method of claim 7, wherein a process correlation determines a relationship between DOC in the first part and temperature and time,
wherein the first critical temperature and the first elapsed time are further determined based on the process correlation to produce the first DOC in the first part.

9. The method of claim 8, wherein the process correlation is determined from at least one of:
(i) a calibration curve having a functional relation between DOC and temperature and time;
(ii) a lookup table having paired values of the first critical temperature and the first elapsed time that produce the first DOC;
(iii) a semi-empirical DOC model of the first part;
(iv) an experimental measurement; or
(v) a plurality of DOC simulations of the first part for a plurality of DOC distinct process conditions, wherein the DOC simulations include thermal chemical models,
wherein the plurality of DOC distinct process conditions includes at least one of:
(i) a plurality of different heated environment temperatures utilized during heating the first part providing different heat transfer coefficients between the heated environment and the first part;
(ii) a plurality of different heating rates for the first part;
(iii) a plurality of different materials and thicknesses for the first part; or
(iv) a plurality of different materials, thicknesses, thermal conductivity, heat capacity and density for the first tool.

10. The method of claim 6, wherein the first critical temperature ranges from about 150 ° F. to about 325 ° F.

11. The method of claim 1, wherein the first DOC is at least 55% and less than 90%, and wherein the second DOC is at least 90%.

12. The method of claim 1, wherein, after the curing to the second DOC, the first part has a cured wet glass transition temperature (Tg) of at least 180 ° F.

13. The method of claim 1, wherein the first tool comprises at least a polymeric component having a Tg of at least 175 ° F. and the first tool has a life-cycle of at least 10.

14. The method of claim 1, wherein the first part comprises a plurality of plies.

15. The method of claim 14, wherein each ply in the plurality of plies includes a composite material, and wherein the composite material includes a resin composition and one or more fibers.

16. The method of claim 15, wherein the resin composition has an out time of at least 7 days.

17. The method of claim 16, wherein the resin composition reaches the first DOC over a time period of at most 180 min at the first critical temperature.

18. The method of claim 16, wherein at least one ply has first regions and a second region therebetween, wherein the second region is cured faster than the first regions.

19. The method of claim 18, wherein the second region includes the one or more fibers and a cure accelerating agent, and wherein the cure accelerating agent is present in a higher concentration in the second region than in the first regions.

20. The method of claim 1, wherein the composite bonded structure comprises at least one of a pi-joint, an adhesive joint, or a sandwich joint.
